(19) United States
(12) Patent Application Publication
(10) Pub. No.: US 2014/0067586 A1
(43) Pub. Date: Mar. 6, 2014

(54) Methods, Apparatuses, and Computer Program Products for Fulfilling Requests for Price Opinions

(71) Applicant: Brad Geisen, Boca Raton, FL (US)

(72) Inventor: Brad Geisen, Boca Raton, FL (US)

(21) Appl. No.: 13/840,808

(22) Filed: Mar. 15, 2013

Related U.S. Application Data
(60) Provisional application No. 61/697,031, filed on Sep. 5, 2012.

(51) Int. Cl. G06Q 30/06

(52) U.S. Cl. CPC G06Q 30/0611
USPC 705/26.4

(57) ABSTRACT

Methods, apparatuses, and computer program products for requesting and receiving price opinions for an asset such as a piece of real estate are provided. In response to a request for a price opinion for an asset, some or all of the data fields for a price opinion may be automatically populated. Optionally, a vendor may be provided with a work order including a partially populated price opinion, which the vendor may then fill in the remainder of the data fields thereof. Regardless, the completed price opinion may be delivered to the requestor.

### BACKGROUND OF THE DISCLOSURE

1. Field of the Disclosure

Aspects of the present disclosure relate to preparation of a price opinion for an asset, and, more particularly, to methods, apparatuses, and computer program products for preparation of a price opinion for an asset.

2. Description of Related Art

Broker price opinions may be of use in a variety of contexts. For example, a seller of a piece of property, such as real estate may wish to know the value of the property prior to listing the piece of property for sale. Conversely, a buyer may wish to know the value of a piece of property prior to making an offer to buy the property. Further, a lender may wish to know the value of a piece of property prior to issuing a loan for the purchase of the property, for example to avoid issues with respect to the buyer purchasing an over-priced piece of property. Additionally, owners of a portfolio of properties and owners of a portfolio of loans on properties may wish to know the value of their portfolios.

### BRIEF SUMMARY OF THE DISCLOSURE

The above and other needs are met by aspects of the present disclosure, wherein one such aspect relates to the preparation of price opinions for assets by pre-populating at least a portion of data fields of a price opinion substantially automatically. Vendors may optionally be employed to receive a remainder of the data fields.

In one aspect a method is provided. The method may include providing for reception of a request for a price opinion for an asset. Further, the method may include populating at least a portion of a plurality of data fields in the price opinion based on an address of the asset via a processor. Additionally, the method may include providing for transmission of the price opinion in response to the request.

In some embodiments the data fields may include a list of comparable assets. The method may additionally include selecting a vendor, providing for issuance of a work order to the vendor requesting completion of a remainder of the data fields of the price opinion, and providing for reception of the remainder of the data fields. Selecting the vendor may include selecting the vendor based on a service type of the vendor and a location identifier of the asset. Selecting the vendor may further comprise selecting the vendor based on a weighted service metric. The method may further include receiving an acceptance or a rejection of the work order from the vendor. A remainder of the data fields may include a plurality of filtered comparable assets selectable from the list of comparable assets.

In some embodiments the method may additionally include validating input of the remainder of the data fields by the vendor. Validating input of the remainder of the data fields may include requiring input of each of the data fields, rejecting input of the data fields outside of an acceptable range within an account specification stored in a computer-readable storage medium, and rejecting input of the data fields outside of an acceptable range within a client specification stored in a computer-readable storage medium. Providing for reception of the request for the price opinion for the asset; providing for population of the portion of a plurality of data fields in the price opinion based on the address of the asset; providing for issuance of the work order to the vendor requesting completion of the remainder of the data fields of the price opinion; providing for reception of the remainder of the data fields; and providing for transmission of the price opinion in response to the request may be conducted via a network.

In an additional aspect an apparatus including at least one processor and at least one memory including computer program code is provided. The at least one memory and the computer program code may be configured to, with the processor, cause the apparatus to provide for reception of a request for a price opinion for an asset, provide for population of at least a portion of a plurality of data fields in the price opinion based on an address of the asset, and provide for transmission of the price opinion in response to the request

In some embodiments the data fields may include a list of comparable assets. The apparatus may be further configured to select a vendor, provide for issuance of a work order to the vendor requesting completion of a remainder of the data fields of the price opinion, and provide for reception of the remainder of the data fields. The apparatus may also be configured to select the vendor based on a service type of the vendor and a location identifier of the asset and/or based on a weighted service metric. The apparatus may additionally be configured to receive an acceptance or a rejection of the work order from the vendor. The remainder of the data fields may include a plurality of filtered comparable assets selectable from the list of comparable assets. The apparatus may be further configured to validate input of the remainder of the data fields by the vendor. Validating input of the remainder of the data fields may include requiring input of each of the data fields, rejecting input of the data fields outside of an acceptable range within an account specification, and rejecting input of the data fields outside of an acceptable range within a client specification.

In an additional aspect a computer program product including at least one computer-readable storage medium having computer-executable program code portions stored therein is provided. The computer-executable program code portions may include program code instructions providing for reception of a request for a price opinion for an asset, program code instructions providing for population of at least a portion of a plurality of data fields in the price opinion based on an address of the asset, and program code instructions providing for transmission of the price opinion in response to the request.

In some embodiments the data fields may include a list of comparable assets. The computer program product may further include program code instructions for selecting a vendor, program code instructions providing for issuance of a work order to the vendor requesting completion of a remainder of the data fields of the price opinion, and program code instructions providing for reception of the remainder of the data fields. Program code instructions for selecting the vendor may include program code instructions for selecting the vendor based on a service type of the vendor and a location identifier of the asset. Program code instructions for selecting the vendor may further include program code instructions for selecting the vendor based on a weighted service metric.

In some embodiments the computer program product may additionally include program code instructions for receiving an acceptance or a rejection of the work order from the vendor. The remainder of the data fields may include a plurality of filtered comparable assets selectable from the list of comparable assets. The computer program product may further include computer program instructions for validating input of the remainder of the data fields by the vendor. Computer program code instructions for validating input of the remainder of the data fields may include computer program instructions for requiring input of each of the data fields, computer program instructions for rejecting input of the data fields outside of an acceptable range within an account specification, and computer program instructions for rejecting input of the data fields outside of an acceptable range within a client specification.

Aspects of the present disclosure thus address the identified needs and provide other advantages as otherwise detailed herein.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 illustrates a schematic block diagram of a system according to an example embodiment of the present disclosure;

FIG. 2 illustrates a schematic block diagram of an apparatus according to an example embodiment of the present disclosure;

FIG. 3 illustrates a schematic block diagram of the apparatus of FIG. 2 including additional components according to an example embodiment of the present disclosure; and

FIG. 4 illustrates a flowchart of the operations performed in a method according to an example embodiment of the present disclosure.

### DETAILED DESCRIPTION OF THE DISCLOSURE

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

The present disclosure relates to the preparation of price opinions, which may also be referred to as broker price opinions, appraisals, and valuations, for assets such as a home, commercial property, or land. In this regard, the present disclosure is generally described in terms of applicability to price opinions for real estate. However, it should be understood that the present disclosure is provided for example purposes only, and the methods, apparatuses, and computer program products described herein may be employed with various other embodiments of assets.

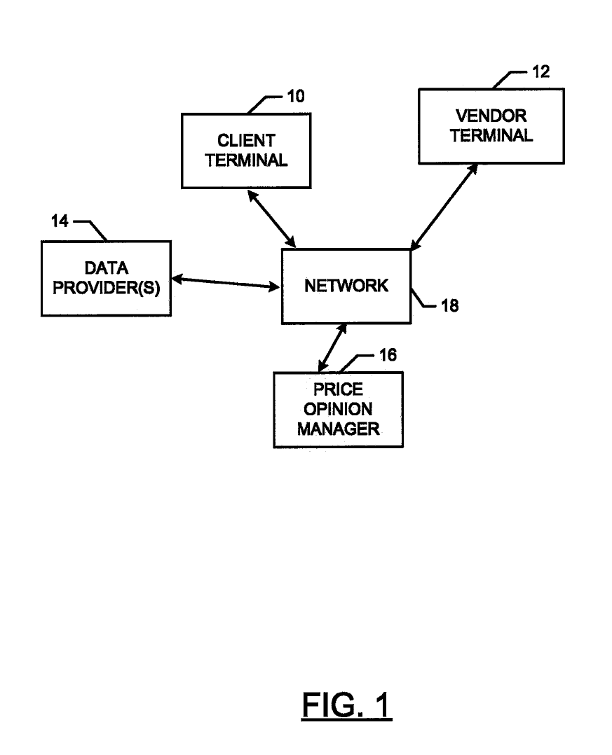

FIG. 1 illustrates a block diagram of a system that may benefit from embodiments of the present disclosure. The system may include a client terminal 10, one or more data providers 14, and a price opinion manager 16. In one embodiment the system may optionally include a vendor terminal 12. The client terminal 10, vendor terminal 12, data providers 14, and price opinion manager 16 may communicate directly or via a network 18. In this regard, the systems, apparatuses, methods, and computer program products may be web-based (e.g., via the internet or other network in some embodiments).

The client terminal 10 may be a computing or communication device which may be stationary or mobile. The client terminal 10 may allow a client to issue a request for a price opinion for an asset to the price opinion manager 16. If the client so chooses, the request for the price opinion may be assigned to a particular pool of employees or other users of the price opinion manager 16, referred to as a task group. Alternatively, in some embodiments the price opinion manager 16 may manage the request substantially automatically without requiring user interaction. Note that in one embodiment the system may be configured such that the client first initiates contact with the price opinion manager 16, rather than the vendor initiating contact with the price opinion manager. In this regard, the present system may be configured for the preparation of price opinions based on requests by clients (e.g., the owners of the assets).

The price opinion manager 16 may be embodied in a variety of forms including, for example, a server, server bank or other computer, computing device, cloud, or node configured to perform the functions described herein. In addition to receiving the request for the price opinion, the price opinion manager 16 may be configured to populate at least a portion of a plurality of data fields in the price opinion based on an address, or other unique identifier for the asset. This information may be provided to the price opinion manager 16 by one or more data providers 14. The data providers 14 may be embodied in a variety of forms including, for example, a server, server bank or other computer, computing device, cloud, or node configured to perform the functions described herein.

The address of the asset may be verified against an address verification provider (which may comprise one of the data providers 14), prior to seeking other data from the data providers. The address verification provider may update the address information regarding the asset to reflect the correct county, city, state, zip code (six or ten digit), latitude and longitude, street address, suite information, and/or other appropriate identifying information. Accordingly, the proper address information may be given to the other data providers 14 when seeking information therefrom in the manner described below.

The price opinion manager 16 may use a processor and the data received from the data providers 14 to pre-populate a portion of the data fields of the price opinion, or fully populate the data fields. Depending on the current status of the asset and the accuracy of available information, in one embodiment up to 80% of the data fields can be pre-filled using this process, whereas in another embodiment substantially all of the data fields may be populated. The data fields provided to the price opinion manager 16 may include Multiple Listing Server (MLS) information regarding the asset, which may fill data fields comprising an asset type, an asset dimension, a bedroom number, and a bathroom number. Additional data fields regarding the asset, which may be pre-populated, may include tax roll information, sales history information regarding the asset, market sales information (e.g., within the past six months), current market data, current market trend data, current rental information. Additional data fields may include information on pricing trends, average time to sale, the number of active listings, local employment trends, number of real estate owned (REO) properties and listed properties, current rent ranges for similar properties in the area, upper and lower range values for neighborhood sales, and home owner association (HOA) information, if applicable. However, various other market and valuation information for the asset may also be pre-populated.

In this regard, by way of further example, the data fields provided by the data providers 14 may also include a list of comparable assets (comparable sales and/or comparable active listings) that have either been sold or listed within a predefined period of time from the present date (e.g., within the past six months) within a comparable area (e.g., within a predefined distance therefrom). In some of the embodiments, the comparable assets may be selected such that they include many of the same features as the asset. Additional data fields provided by the data providers 14 may include area high and low sales values, supply of comparable listings, and time on market. Further, the data providers 14 may provide a data field comprising a photo (e.g., a street view photo) of the asset or other related media.

Information received from the data providers 14 may be associated with the price opinion that is generated (e.g., placed in an electronic document). The information provided by the data providers 14 may also be separately stored in its original form and associated with the respective data providers for accounting purposes. Further, the information placed in the price opinion regarding comparable sales and/or listings may be assigned a score by the price opinion manager 16. The score may be calculated based on the similarity of each comparable listing/sale to the asset. For example, the price opinion manager 16 may compare various information such as square footage, property type, bedroom and bathroom count, lot size, and presence of extras such as a pool or patio. The comparable listings/sales may each include their geographic location such that, optionally, a vendor may easily review them in the manner discussed below.

Accordingly, in some embodiments a price opinion may be completed by the price opinion manager 16 substantially automatically. In this regard, various data fields relating to the asset may be pre-populated substantially without any user intervention. However, in other embodiments further information or analysis may be desired. In this regard, as discussed below, a vendor may be employed. However, regardless of whether a vendor is employed, a price opinion may be transmitted to a requestor in response to the request. The price opinion may include some or all of the various data fields discussed herein such as a map of the asset, a list of comparables, and a photo of the asset.

In some embodiments the price opinion manager 16 may also select a vendor for completion of the price opinion. A vendor, as used herein, refers to any service provider that may provide information relating to an asset. In one embodiment a vendor may be a service provider that provides valuation and/or market information relating to an asset. For example, a vendor may comprise a real estate agent or a home inspector.

Selecting the vendor may be conducted automatically, or by a processor or other user or employee within an account employing the price opinion manager 16. Selecting the vendor may comprise selecting the vendor based on a service type of the vendor (e.g., whether or not the vendor works with commercial properties) and whether a location identifier (e.g., a zip code) of the asset falls within a service area provided by the vendor. The vendors may also be selected based on a weighted service metric. For example, vendors may be selected based on criteria including turnaround time for completed work, average rate that they charge for a service, work quality, and vendor/account relationship. Each account employing the price opinion manager 16 can specify their own scoring criteria for a particular vendor to affect the vendor's weighted score, or default values may be employed.

In this regard, the price opinion manager 16 may provide for issuance of a work order to the vendor terminal 12 which has been selected requesting completion of a remainder of the data fields of the price opinion. The vendor terminal 12 may be a computing or communication device which may be stationary or mobile. The vendor terminal 12 may allow a vendor to receive a work order from the price opinion manager 16 requesting completion of a remainder of the data fields of the price opinion. The price opinion manager 16 may then receive an acceptance or a rejection of the work order from the vendor terminal 12. The vendor can accept or reject the work order based on work load, specified payment for the work, distance, or other criteria. If the vendor rejects the work order, the vendor may be required to provide a reason for the rejection to the price opinion manager 16. Further, if the vendor rejects the work order, the price opinion manager 16 may repeat the selection process described above, while excluding the previously selected vendor from the available options.

The work order can be created manually by a manager of an account, or it can be automatically issued by the price opinion manager 16. The work order may be configurable by account and client constraints. Customizations may include: instructions to the vendor and document templates, client specific instructions to the vendor, task assignments and escalation procedures, and vendor relationship data points and metrics. The work order may include instructions, a title, a due date, and an approved payment amount. The price opinion manager 16, or a processor within an account employing the price opinion manager, may assign an additional tracking identification to synch with external systems, if desired. Thereby, changes to the work order and communications about the work performed may be directly linked to the work order, in addition to any instructions and any deliverables provided during the work order lifetime.

The vendor analyzes the pre-filled data fields and completes any remaining data fields on a section by section basis to finish the price opinion. When the vendor attempts to complete the price opinion, the price opinion manager 16 may validate input of each of the remainder of the data fields. Validating input of the remainder of the data fields may comprise requiring input of each of the data fields (which may be checked based on type and range of inputted data), rejecting input of the data fields outside of an acceptable range within an account specification, and/or rejecting input of the data fields outside of an acceptable range within a client specification. These client and account specified values may be stored in a computer-readable storage medium and compared to the inputted values. Validation of the data fields that are inputted may be conducted as each section is completed and/or when the vendor attempts to submit the price opinion to the price opinion manager 16. A script-based rules engine may implement verification of the inputted data fields.

In some embodiments the remainder of the data fields that a vendor must complete may include a plurality of filtered comparable assets selectable from the list of comparable assets provided to the vendor by the price opinion manager 16. These filtered comparable assets are intended to more closely approximate the value of the subject asset. The price opinion manager 16 may provide the vendor with a map of sales and listings of assets that may be color coordinated by type, with the ability to select up to a required number of sales or listing as filtered comparable assets. The required number of filtered comparable assets may be configurable based on the type of price opinion requested.

Each comparable asset provided by the price opinion manager 16 may have data fields associated therewith such as an asset type, an asset dimension (e.g., gross square feet of lot and/or building), a bedroom number, a bathroom number, a distance to the asset, a sale or listing date and price, an address, whether the property has a pool, etc. The vendor may sort the comparable assets based on these and various other factors. A picture of each of the comparable assets may also be provided to the vendor. The vendor may select each comparable asset for a more detailed view of the information relating thereto. Upon selecting a comparable asset, the map view may center on the selected comparable asset as opposed to the asset subject to valuation. This provides the vendor with an immediate view of how close the two assets are as well as neighborhood. The price opinion may not be completed until the vendor selects an appropriate number of comparables for inclusion in the filtered comparable assets. If, for some reason, the number of comparable assets available is less than the number of comparable assets required to complete the price opinion, the vendor may either manually add additional assets or adjust the default search criteria.

When a vendor selects comparable assets for inclusion in the filtered comparable assets, the price opinion manager 16 may run an additional property information query against the data providers 14. This is to ensure that some or all of the data fields relating to the selected comparable asset is prefilled for the vendor, and any appropriate photos of the comparable asset are provided in the price opinion. The vendor may then perform a visual inspection of the filtered comparable assets, which may be required by the price opinion manager 16 in some embodiments, such that the vendor may confirm or edit information pre-filled by the price opinion manager, as may be appropriate. For example, the vendor may edit or add information regarding the comparable assets based on perceived quality of construction, condition, design, and appeal of the comparable assets in comparison to the asset being valued.

Also, the vendor may be required by the price opinion manager 16 to upload one or more photos of the subject asset and/or the comparable assets selected for inclusion in the list of filtered comparable assets. The price opinion manager 16 may allow uploading of images of the asset, comparables, and repairs required as appropriate to the condition of the subject asset and the comparable assets. These data fields, which may be required for the completion of the price opinion in some embodiments, may be performed in any order by the vendor. The price opinion manager may keep track of each of the price opinion sections and subsections and their completion statuses for the vendor. The vendor may also be required to recommend a strategy for sale and determine a likely buyer based on the available information. Additionally, all needed repairs to the asset undergoing valuation may be documented with an estimated cost to repair, and an indication as to whether they should be completed prior to sale.

Upon completion of the price opinion, the vendor (e.g., through the vendor terminal 12) may attach the price opinion to the work order, and return the completed price opinion to the price opinion manager 16, which may in turn provide the completed price opinion to the client (e.g., through the client terminal 10). Prior to providing the price opinion to the client, the price opinion may be reviewed by a reviewer within the account employing the price opinion manager 16. The reviewer may examine the price opinion, and either accept or reject the price opinion for submission to the client (e.g., through the client terminal 10).

The data fields initially populated by the price opinion manager 16 and provided to the vendor may be attached as an addendum to the price opinion or included in the body thereof. The completed price opinion may be generated from a combination of all vendor provided information, asset and comparable asset photos, and information initially provided by the price opinion manager 16. A document template may be provided for the vendor's use by the price opinion manager 16. The document template may be branded to the account's specifications in some embodiments.

If the price opinion is rejected for missing or inaccurate data, the reviewer within the account employing the price opinion manager 16 (or the price opinion manager itself) may identify the information missing from the price opinion in rejection notes. These notes may be attached to the work order, the price opinion may be marked incomplete, and the price opinion may be returned to the vendor for completion. In response to the rejection, the vendor may adjust the data fields or provide additional information to justify the data fields and resubmit.

Accordingly, the price opinion may be created based substantially entirely on pre-filled information automatically provided by data providers, or the price opinion can further include information provided by a vendor. Regardless, upon completion of the price opinion, the price opinion may be attached to the asset (e.g., in the event that the asset is subject to a loan request), or delivered to the client that requested the price opinion (e.g., through the client terminal 10). If the client that requested the price opinion requires additional information, the work order may be returned to the vendor with the price opinion marked as incomplete by the price opinion manager 16.

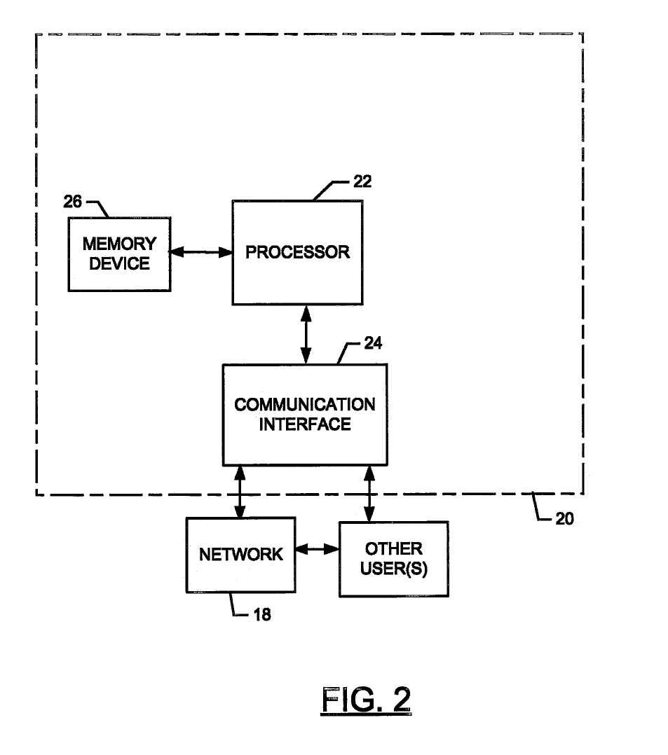

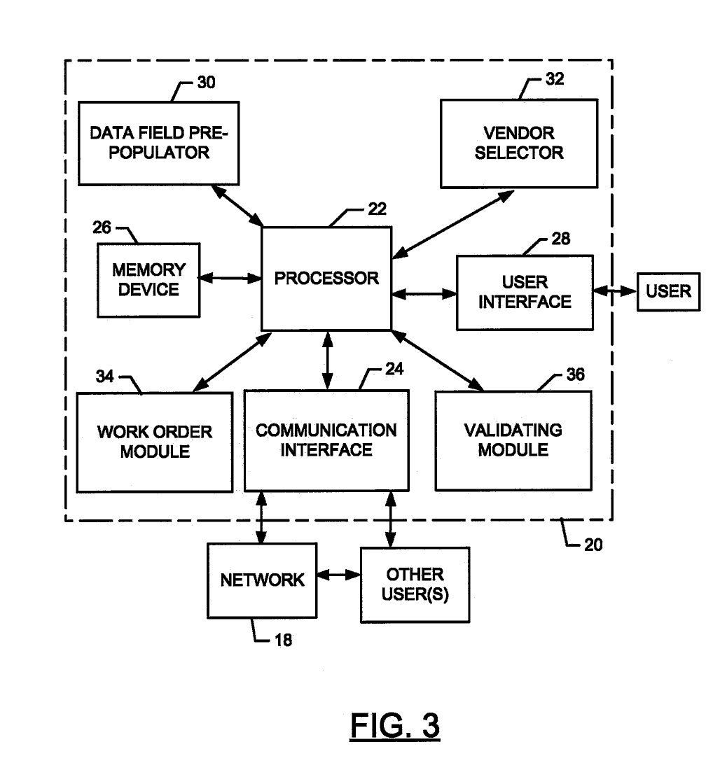

In example embodiments illustrated in FIGS. 2 and 3, an apparatus 20 is provided that may be employed by devices performing functions in accordance with example embodiments of the present disclosure. The apparatus 20 may be embodied as, comprise, control, or otherwise be associated with the client terminal 10, the vendor terminal 12, the data providers 14, and/or the price opinion manager 16. However, the apparatus 20 is generally described herein as being embodied, at least primarily, on the price opinion manager 16. Embodiments of the apparatus 20 may also be distributed across a plurality of devices such as for example where instances of the apparatus may be embodied on the network 18. Further, in some embodiments, the apparatus 20 may be physically embodied as a chip or chip set configured to perform one or more operations for providing the functionalities described herein. As such, embodiments of the apparatus 20 illustrated in FIGS. 2 and 3 are merely examples and may include more, or in some cases, less than the components shown in FIGS. 2 and 3.

With further regard to FIGS. 2 and 3, the apparatus 20 may be configured to provide for reception of a request for a price opinion for an asset and populate at least a portion of a plurality of data fields in the price opinion based on an address of the asset. In some embodiments the apparatus may be additionally configured to provide for selection of a vendor, provide for issuance of a work order to the vendor requesting completion of a remainder of the data fields of the price opinion, and provide for reception of the remainder of the data fields to complete the price opinion, as described above.

As depicted in FIG. 2, the apparatus 20 may include or otherwise be configured to communicate with a processor 22, a communication interface 24, and a memory device 26. The processor 22 may comprise any of various processing means such as a coprocessor, a digital signal processor (DSP), a microprocessor, a controller, processing circuitry, integrated circuits (e.g., a special-purpose computer chip), or other processor. The processor 22 may be configured to execute instructions stored in the memory device 26 or otherwise accessible to the processor and/or configured to execute hard coded functionality. Thus, the processor 22 may be specifically configured to perform the functions described herein, or the processor may be configured to execute software instructions that configure the processor to perform the operations described herein. The processor 22 may include standard processor components including, for example, an arithmetic logic unit (ALU), a clock, and logic gates.

The communication interface 24 may be configured to receive and/or transmit data. In this regard, the communication interface 24 may comprise software and/or hardware configured for this functionality, such as an antenna with supporting hardware and software.

The memory device 26 may comprise a computer-readable storage medium. As used herein, a computer-readable storage medium refers to a non-transitory, physical storage medium (e.g., a volatile or non-volatile memory device), as opposed to an electromagnetic signal. The memory device 26 may be configured to store data. For example, the memory device may buffer data for processing by the processor 22 and/or store instructions for execution by the processor.

FIG. 3 illustrates an embodiment of the apparatus 20 comprising additional components or modules configured to perform the functions described above. The apparatus 20 may include or otherwise be in communication with the processor 22, the communication interface 24, and the memory device 26 as described above with respect to FIG. 2.

In some embodiments the apparatus 20 may further comprise a user interface 28. The user interface 28 may be in communication with the processor 22 to receive an indication of a user input and/or to provide an output to the user (e.g., audible or visible). As such, the user interface 28 may include, for example, a keyboard, a mouse, a joystick, a display, a touch screen, a microphone, a speaker, and/or other input/output device.

In some embodiments the apparatus 20 may further comprise a data field pre-populator 30. The data field pre-populator 30 may be configured to perform one or more functions with respect to populating at least a portion of a plurality of data fields in the price opinion based on an address of the asset or other unique identifier thereof. The processor 22 may be embodied as, include or otherwise control the data field pre-populator 30.

The apparatus 20 may further comprise a vendor selector 32. The vendor selector 32 may be configured to perform one or more functions with respect to selecting a vendor. The processor 22 may be embodied as, include or otherwise control the vendor selector 32.

The apparatus 20 may further comprise a work order module 34. The work order module 34 may be configured to perform one or more functions with respect to providing for issuance of a work order to the vendor requesting completion of a remainder of the data fields of the price opinion. The processor 22 may be embodied as, include or otherwise control the work order module 34.

The apparatus 20 may further comprise a validating module 36. The validating module 36 may be configured to perform one or more functions with respect to validating input of the remainder of the data fields by the vendor. As described above, validating input of the remainder of the data fields may comprise requiring input of each of the data fields, rejecting input of the data fields outside of an acceptable range within an account specification, and/or rejecting input of the data fields outside of an acceptable range within a client specification. The processor 22 may be embodied as, include or otherwise control the validating module 36.

Additionally, the communication interface 26 may initially provide for reception of a request for a price opinion for an asset and provide for reception of the remainder of the data fields to complete the price opinion when provided by the vendor, as described above. Further, the communication interface 26 may provide for transmission of the completed price opinion to the client.

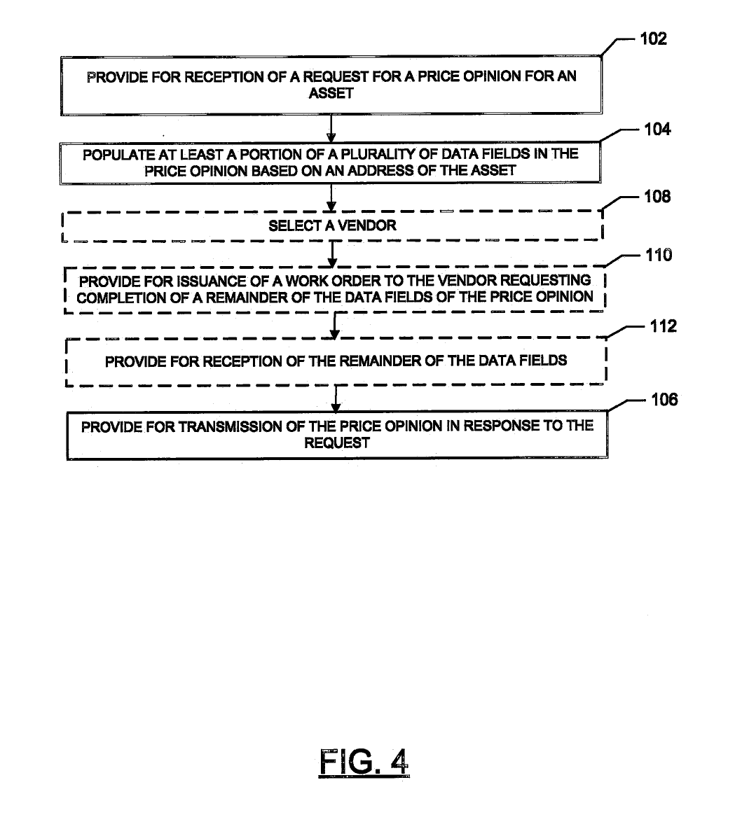

In terms of methods associated with embodiments of the present disclosure, the above-described apparatus 20 or other apparatuses may be employed. In this regard, FIG. 4 is a flowchart of a system, method and program product according to an example embodiment. The operations illustrated in FIG. 4 may be conducted by hardware, firmware, a processor, circuitry and/or other devices. These devices may be specially configured to perform the specified functions. Further, the computer program instructions may be stored in a computer-readable storage medium which, when executed, implements the illustrated operations.

The method may include providing for reception of a request for a price opinion for an asset at operation 102. Further, the method may include populating at least a portion of a plurality of data fields in the price opinion based on an address of the asset at operation 104. Additionally, the method may include providing for transmission of the price opinion in response to the request at operation 106. Accordingly, the price opinion may be at least partially completed substantially automatically in response to the request.

However, in other embodiments additional or alternative information may be desired. Accordingly, the method may also include selecting a vendor at operation 108. Additionally, the method may include providing for issuance of a work order to the vendor requesting completion of a remainder of the data fields of the price opinion at operation 110. The method may further comprise providing for reception of the remainder of the data fields to complete the price opinion at operation 112.

In some embodiments selecting the vendor at operation 108 may comprise selecting the vendor based on a service type of the vendor and a location identifier of the asset and/or selecting the vendor based on a weighted service metric. The method may also include receiving an acceptance or a rejection of the work order from the vendor. In some embodiments the data fields may comprise a list of comparable assets, although various other embodiments of data fields that may be pre-populated are described above. Further, the remainder of the data fields may comprise a plurality of filtered comparable assets selectable from the list of comparable assets. The method may also include validating input of the remainder of the data fields by the vendor. Validating input of the remainder of the data fields may comprise requiring input of each of the data fields, rejecting input of the data fields outside of an acceptable range within an account specification (which may be stored in a computer-readable storage medium), and/or rejecting input of the data fields outside of an acceptable range within a client specification (which may be stored in a computer-readable storage medium). In some embodiments providing for reception of the request for the price opinion for the asset at operation 102; providing for population of the portion of a plurality of data fields in the price opinion based on the address of the asset at operation 104; providing for transmission of the price opinion in response to the request at operation 106; providing for issuance of the work order to the vendor requesting completion of the remainder of the data fields of the price opinion at operation 110; and providing for reception of the remainder of the data fields to complete the price opinion at operation 112 may be conducted via a network such as the internet. In this regard, the methods, apparatuses, and computer program product may be web-based in some embodiments.

In an example embodiment, an apparatus for performing the method of FIG. 4 and other methods described above may comprise a processor (for example, the processor 22) configured to perform some or each of the operations (102-112) described above. The processor may, for example, be configured to perform the operations (102-112). Alternatively, the apparatus may comprise means for performing each of the operations described above. Example means for performing the operations (102-112) may comprise, for example, the processor 22, the communication interface 24, the user interface 28, the data field pre-populator 30, the vendor selector 32, work order module 34, and/or the validating module 36, as described above.

In some embodiments providing for reception of a request for a price opinion for an asset at operation 102 may be conducted by means, such as the communication interface 24, the user interface 28, and/or the processor 22. Additionally, populating a portion of a plurality of data fields in the price opinion based on an address of the asset at operation 104 may be conducted by means, such as the data field pre-populator 30, the communication interface 24, and/or the processor 22. Further, providing for transmission of the price opinion in response to the request at operation 106 may be may be conducted by means, such as the communication interface 24, the user interface 28, and/or the processor 22. Also, providing for selection of a vendor at operation 108 may be conducted by means, such as the vendor selector 32, the user interface 28, and/or the processor 22. Additionally, providing for issuance of a work order to the vendor requesting completion of a remainder of the data fields of the price opinion at operation 110 may be conducted by means, such as the work order module 34, the communication interface 24, and/or the processor 22. Further, providing for reception of the remainder of the data fields to complete the price opinion at operation 112 may be conducted by means, such as the communication interface 24, the work order module 34, the validating module 36, and/or the processor 22.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Although specific terms are employed herein, they are used in a generic and descriptive sense only and not for purposes of limitation.

That which is claimed:

1. A method, comprising:
providing for reception of a request for a price opinion for an asset;
populating at least a portion of a plurality of data fields in the price opinion based on an address of the asset via a processor; and
providing for transmission of the price opinion in response to the request.

2. The method of claim 1, wherein the data fields comprise a list of comparable assets.

3. The method of claim 1, further comprising:
selecting a vendor;
providing for issuance of a work order to the vendor requesting completion of a remainder of the data fields of the price opinion; and
providing for reception of the remainder of the data fields.

4. The method of claim 3, wherein selecting the vendor comprises selecting the vendor based on a service type of the vendor and a location identifier of the asset.

5. The method of claim 4, wherein selecting the vendor further comprises selecting the vendor based on a weighted service metric.

6. The method of claim 3, further comprising receiving an acceptance or a rejection of the work order from the vendor.

7. The method of claim 3, wherein the remainder of the data fields comprise a plurality of filtered comparable assets selectable from the list of comparable assets.

8. The method of claim 3, further comprising validating input of the remainder of the data fields by the vendor, wherein validating input of the remainder of the data fields comprises:
requiring input of each of the data fields;
rejecting input of the data fields outside of an acceptable range within an account specification stored in a computer-readable storage medium; and
rejecting input of the data fields outside of an acceptable range within a client specification stored in a computer-readable storage medium.

9. The method of claim 3, wherein providing for reception of the request for the price opinion for the asset; providing for population of the portion of a plurality of data fields in the price opinion based on the address of the asset; providing for issuance of the work order to the vendor requesting completion of the remainder of the data fields of the price opinion; providing for reception of the remainder of the data fields; and providing for transmission of the price opinion in response to the request are conducted via a network.

10. An apparatus comprising at least one processor and at least one memory including computer program code, the at least one memory and the computer program code configured to, with the processor, cause the apparatus to:
provide for reception of a request for a price opinion for an asset;
provide for population of at least a portion of a plurality of data fields in the price opinion based on an address of the asset;
provide for transmission of the price opinion in response to the request.

11. The apparatus of claim 10, wherein the data fields comprise a list of comparable assets.

12. The apparatus of claim 10, further configured to:
select a vendor;
provide for issuance of a work order to the vendor requesting completion of a remainder of the data fields of the price opinion; and
provide for reception of the remainder of the data fields.

13. The apparatus of claim 12, further configured to select the vendor based on a service type of the vendor and a location identifier of the asset.

14. The apparatus of claim 13, further configured to select the vendor based on a weighted service metric.

15. The apparatus of claim 12, further configured to receive an acceptance or a rejection of the work order from the vendor.

16. The apparatus of claim 12, wherein the remainder of the data fields comprise a plurality of filtered comparable assets selectable from the list of comparable assets.

17. The apparatus of claim 12, further configured to validate input of the remainder of the data fields by the vendor, wherein validating input of the remainder of the data fields comprises:
requiring input of each of the data fields;
rejecting input of the data fields outside of an acceptable range within an account specification; and
rejecting input of the data fields outside of an acceptable range within a client specification.

18. A computer program product comprising at least one computer-readable storage medium having computer-executable program code portions stored therein, the computer-executable program code portions comprising:
program code instructions providing for reception of a request for a price opinion for an asset;
program code instructions providing for population of at least a portion of a plurality of data fields in the price opinion based on an address of the asset; and
program code instructions providing for transmission of the price opinion in response to the request.

19. The computer program product of claim 18, wherein the data fields comprise a list of comparable assets.

20. The computer program product of claim 18, further comprising program code instructions for selecting a vendor;
program code instructions providing for issuance of a work order to the vendor requesting completion of a remainder of the data fields of the price opinion; and
program code instructions providing for reception of the remainder of the data fields.

21. The computer program product of claim 20, wherein program code instructions for selecting the vendor comprise program code instructions for selecting the vendor based on a service type of the vendor and a location identifier of the asset.

22. The computer program product of claim 21, wherein program code instructions for selecting the vendor further comprise program code instructions for selecting the vendor based on a weighted service metric.

23. The computer program product of claim 20, further comprising program code instructions for receiving an acceptance or a rejection of the work order from the vendor.

24. The computer program product of claim 20, wherein the remainder of the data fields comprise a plurality of filtered comparable assets selectable from the list of comparable assets.

25. The computer program product of claim 20, further comprising computer program instructions for validating input of the remainder of the data fields by the vendor, wherein computer program code instructions for validating input of the remainder of the data fields comprise:
computer program instructions for requiring input of each of the data fields;
computer program instructions for rejecting input of the data fields outside of an acceptable range within an account specification; and
computer program instructions for rejecting input of the data fields outside of an acceptable range within a client specification.
